(19) United States
(12) Patent Application Publication
(10) Pub. No.: US 2025/0361740 A1
(43) Pub. Date: Nov. 27, 2025

(54) ROBOTIC POOL CLEANER

(71) Applicant: XINGMAI INNOVATION TECHNOLOGY (SUZHOU) CO., LTD., Suzhou (CN)

(72) Inventor: Shilei ZHANG, Suzhou, Jiangsu (CN)

(73) Assignee: XINGMAI INNOVATION TECHNOLOGY (SUZHOU) CO., LTD., Suzhou (CN)

(21) Appl. No.: 19/293,715

(22) Filed: Aug. 7, 2025

Related U.S. Application Data
(63) Continuation-in-part of application No. PCT/CN2023/086050, filed on Apr. 3, 2023.

(30) Foreign Application Priority Data
Feb. 7, 2023 (CN) 202310076087.X

(51) Int. Cl. E04H 4/16

(52) U.S. Cl. CPC E04H 4/1654

(57) ABSTRACT

A robotic pool cleaner is provided. The robotic pool cleaner includes a cleaning channel, where when the robotic pool cleaner works, garbage and sewage are drawn in through an inlet of the cleaning channel and discharged through an outlet of the cleaning channel; a shell, where the cleaning channel is disposed in the shell; a water pressure sensing mechanism, including a sensing part which is configured to sense a water pressure at a position where the sensing part is disposed, where the sensing part is disposed at an area outside the cleaning channel; and an accommodating cavity configured to accommodate the sensing part. The shell is provided with a first water through hole configured to allow water in a pool to enter the accommodating cavity and then fill the accommodating cavity when the robotic pool cleaner dives into water.

### CROSS-REFERENCE TO RELATED APPLICATIONS

The present disclosure is a continuation-in-part of International Patent Application No. PCT/CN2023/086050 filed on Apr. 3, 2023, which claims priority to: Chinese Patent Application No. 202310076087.X, filed with the China National Intellectual Property Administration on Feb. 7, 2023, all of which are hereby incorporated by reference herein.

### TECHNICAL FIELD

The disclosure relates to the technical field of robotic pool cleaners, and specifically relates to a robotic pool cleaner.

### BACKGROUND

A robotic pool cleaner can automatically clean a bottom surface, a side wall, and a water surface of a pool, providing convenience for users. Especially in terms of a swimming pool which needs to be cleaned frequently, the robotic pool cleaner is widely favored by the users. At present, when the common robotic pool cleaner cleans an internal surface of the pool, the robotic pool cleaner does not know depth information of a current position of the robotic pool cleaner. Consequently, the robotic pool cleaner does not know whether the robotic pool cleaner has been above the water surface, whether the robotic pool cleaner has sunk to the bottom, and a depth of the robotic pool cleaner in water when the robotic pool cleaner is moving on the wall, finally leading to a failure of realizing some intelligent functions.

In order to solve the above problems, it is urgent to provide a robotic pool cleaner to solve the problem that the robotic pool cleaner cannot identify the depth of the robotic pool cleaner.

### SUMMARY

Some embodiments of the present disclosure provide a robotic pool cleaner. A water pressure sensing mechanism is disposed in a non-negative pressure area and configured to directly detect a static pressure underwater, so that the robotic pool cleaner can identify a position of the robotic pool cleaner in water with high accuracy.

In order to solve the above problem, the disclosure provides a robotic pool cleaner. The robotic pool cleaner includes: a cleaning channel, where when the robotic pool cleaner works, garbage and sewage are drawn in through an inlet of the cleaning channel and discharged through an outlet of the cleaning channel; and a shell, where the cleaning channel is disposed in the shell. The robotic pool cleaner further includes: a water pressure sensing mechanism, including a sensing part which is configured to sense a water pressure at a position where the sensing part is disposed, where the sensing part is disposed at an area, other than the cleaning channel, in the shell. The robotic pool cleaner further includes: an accommodating cavity configured to accommodate the sensing part. The shell is provided with a first water through hole configured to allow water in a pool to enter the accommodating cavity and then fill the accommodating cavity when the robotic pool cleaner dives into water.

In some embodiments, the accommodating cavity is formed by a body and a partition of the shell.

In some embodiments, the body is provided with a first groove, and the partition covers an opening of the first groove to form the accommodating cavity.

In some embodiments, the partition is provided with the first water through hole.

In some embodiments, the partition is detachably fitted with the body.

In some embodiments, the partition is provided with at least two second grooves for gripping the partition.

In some embodiments, the partition is hermetically connected to an inner wall of the body so as to form the accommodating cavity.

In some embodiments, the first water through hole is an elongated hole configured to allow water to flow into and flow out of the accommodating cavity.

In some embodiments, the first water through hole is an elongated hole, there are a plurality of elongated holes, and the plurality of elongated holes are arranged in parallel and at intervals.

In some embodiments, there are a plurality of first water through holes, and the plurality of first water through holes are arranged in an array.

In some embodiments, the water pressure sensing mechanism further includes a casing which covers the sensing part, and the casing is provided with a second water through hole.

In some embodiments, the casing is utilized as a filter.

### BRIEF DESCRIPTION OF THE DRAWINGS

To describe the technical solutions in the embodiments of the present disclosure more clearly, the following briefly introduces the accompanying drawings required for describing the embodiments of the present disclosure. Apparently, the accompanying drawings in the following description show only some embodiments of the present disclosure, and a person of ordinary skill in the art can still derive other drawings from the contents in the embodiments of the present disclosure and these accompanying drawings without creative efforts.

FIG. 1 illustrates a schematic structural view of a robotic pool cleaner according to an embodiment of the present disclosure;

FIG. 2 illustrates a schematic sectional structural view of a robotic pool cleaner according to an embodiment of the present disclosure; and

FIG. 3 illustrates a partial enlarged view of A in FIG. 1.

### REFERENCE NUMERALS

100. shell; 110. body; 120. partition; 121. first water through hole; 122. second groove; 130. accommodating cavity;
200. water pressure sensing mechanism; 210. sensing part;
300. cleaning channel;
400. control mechanism;
500. driving mechanism.

### DETAILED DESCRIPTION OF THE EMBODIMENTS

The present disclosure will be further described in detail below with reference to the accompanying drawings and embodiments. It can be understood that the specific embodiments described herein are only used to explain the present disclosure, but not to limit the present disclosure. In addition, it should also be noted that for the convenience of description, only a part of the structures related to the present disclosure rather than all the structures are shown in the accompanying drawings.

In the description of the present disclosure, unless otherwise expressly specified and defined, the terms “connected to”, “connected with”, and “fixed” should be construed in a broad sense. For example, two elements can be fixedly connected, detachably connected or integrally connected; or can be mechanically connected or electrically connected; or can be directly connected or indirectly connected through an intermediate medium; or can be in internal communication or interact with each other. For those of ordinary skill in the art, the specific meaning of the above terms in the present disclosure can be understood according to specific situations.

In the present disclosure, unless otherwise clearly specified and defined, that a first feature is “above” or “below” a second feature may be that the first feature may be in direct contact with the second feature, or the first feature may be in contact with the second feature through another feature between the first feature and the second feature instead of being in direct contact with the second feature. In addition, that the first feature is “above”, “on”, or “over” the second feature may be that the first feature is right above or obliquely above the second feature, or merely mean that a horizontal height of the first feature is greater than that of the second feature. That the first feature is “below”, “underneath”, or “under” the second feature may be that the first feature is right below or obliquely below the second feature, or merely mean that a horizontal height of the first feature is less than that of the second feature.

In descriptions of embodiments, an orientation or position relationship indicated by terms “above”, “below”, “left”, “right”, and the like is an orientation or position relationship based on the accompanying drawings, and is only intended to facilitate descriptions and simplify operations, but is not intended to indicate or imply that an apparatus or an element needs to have a specific orientation and be constructed and operated in a specific orientation. Therefore, such terms cannot be understood as a limitation on the present disclosure. In addition, the terms “first” and “second” are merely used to distinguish in description and have no special meaning.

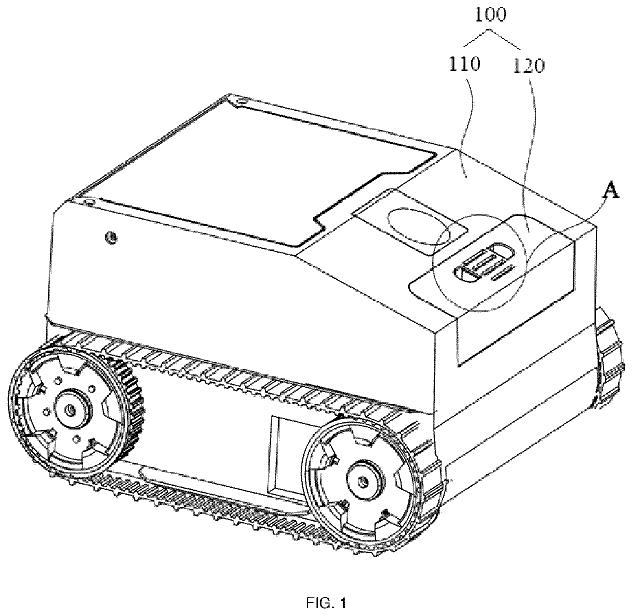

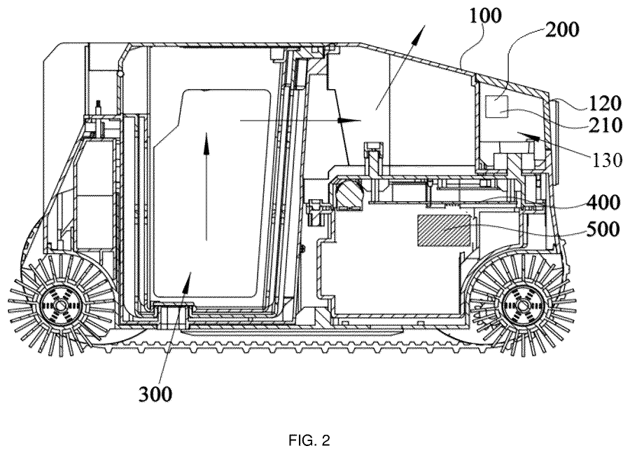

As shown in FIG. 1 and FIG. 2, this embodiment provides a robotic pool cleaner. The robotic pool cleaner is used for cleaning a pool. The robotic pool cleaner includes a control mechanism 400 and a driving mechanism 500. The driving mechanism 500 is electrically connected to the control mechanism 400. The control mechanism 400 can control the driving mechanism 500 to start and stop. In this disclosure, when the robotic pool cleaner reaches a bottom of the pool, the driving mechanism 500 starts. When the robotic pool cleaner leaves a water surface, the driving mechanism 500 stops, thereby maximally saving electric energy. The driving mechanism 500 refers to a structure capable of driving the robotic pool cleaner to perform a cleaning operation, and the driving mechanism 500 includes, but is not limited to, motors and/or transmission devices (such as gears or transmission belts) of the following several types of devices: a device (such as a wheel) configured to allow the robotic pool cleaner to move, a device (such as a water pump) configured to suck garbage and sewage, and a device (such as a rolling brush) configured to clean garbage.

The control mechanism 400 includes, but is not limited to, a microcontroller, an embedded control system, an application-specific integrated circuit (ASIC), and the like. The control mechanism 400 may obtain various pieces of data information of the robotic pool cleaner, and analyze and process the obtained data information, so as to control various components of the robotic pool cleaner. The control mechanism 400 may be integrated on the robotic pool cleaner or may be independent of the robotic pool cleaner and electrically connected to the robotic pool cleaner.

However, in the conventional technology, when the robotic pool cleaner cleans an internal surface of the pool, the robotic pool cleaner does not know depth information of a current position of the robotic pool cleaner. Consequently, the robotic pool cleaner does not know whether the robotic pool cleaner has been above the water surface, whether the robotic pool cleaner has sunk to the bottom, and a depth of the robotic pool cleaner in water when the robotic pool cleaner is moving on the wall, finally leading to a failure of realizing some intelligent functions.

As shown in FIG. 2, in order to solve the above problems, the robotic pool cleaner further includes a shell 100 and a water pressure sensing mechanism 200. The water pressure sensing mechanism 200 is disposed in a non-negative pressure area of the shell 100. The water pressure sensing mechanism 200 includes a sensing part 210. The sensing part 210 is disposed in the non-negative pressure area. The sensing part 210 can sense a water pressure at a position where the sensing part 210 is disposed, so that the robotic pool cleaner can perform a corresponding intelligent operation based on the position of the robotic pool cleaner in water. It may be understood that there exist a static pressure and a dynamic pressure underwater. The depth of the robotic pool cleaner is usually calculated based on the static pressure, and the dynamic pressure underwater may affect detection accuracy of the depth. Therefore, the water pressure sensing mechanism 200 is disposed in the non-negative pressure area where the sensing part 210 can only sense the static pressure. This reduces an impact of the dynamic pressure underwater on calculation accuracy of the depth and helps the sensing part 210 accurately identify the depth of the sensing part 210 in water, thereby assisting the robotic pool cleaner in accurately determining the position of the robotic pool cleaner in water and improving identification accuracy.

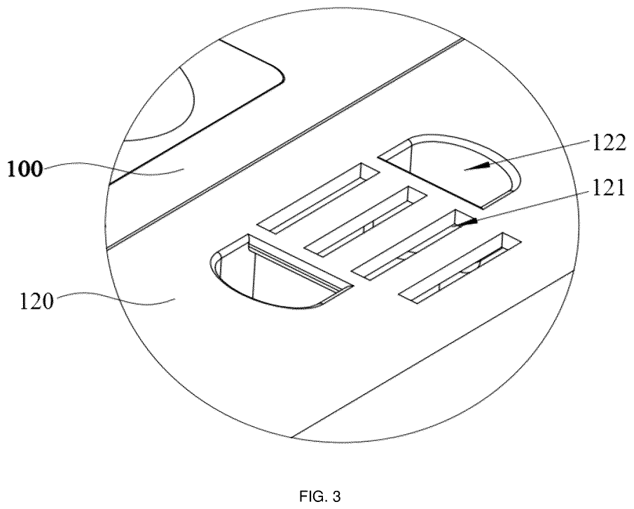

As shown in FIG. 2 and FIG. 3, it may be understood that the robotic pool cleaner is used for cleaning underwater garbage, so the robotic pool cleaner further includes a cleaning channel 300. The cleaning channel 300 runs through the shell 100 from a bottom to a top. When the robotic pool cleaner works, garbage and sewage are drawn in through an inlet of the cleaning channel 300 and discharged through an outlet of the cleaning channel 300.

In some embodiments, when the robotic pool cleaner works, there is a continuous flow of water in the cleaning channel 300, so the water pressure sensing mechanism 200 is not suitable to be disposed in the cleaning channel. Therefore, the non-negative pressure area is an area, other than the cleaning channel 300, in the shell 100, thereby ensuring that the sensing part 210 disposed in the non-negative pressure area performs detection in a static pressure environment.

In some embodiments, when the water pressure sensing mechanism 200 is used in combination with the driving mechanism, the robotic pool cleaner can correctly determine, by using the water pressure sensing mechanism 200, whether the robotic pool cleaner has reached the bottom of the pool. Specifically, after the water pressure sensing mechanism 200 sends, to the control mechanism 400, information indicating that the robotic pool cleaner has reached the bottom of the pool, the control mechanism 400 may control the driving mechanism 500 to start. After the robotic pool cleaner finishes working, the water pressure sensing mechanism 200 sends, to the control mechanism 400, information indicating that the robotic pool cleaner has left the water surface of the pool, and then, the control mechanism 400 may control the driving mechanism 500 to stop, thereby saving the electric energy.

In some embodiments, the robotic pool cleaner further includes a map planning module. The map planning module is configured to draw a pool bottom map and plan a movement path of the robotic pool cleaner during a cleaning process. When the map planning module is used in combination with the water pressure sensing mechanism 200, the water pressure sensing mechanism 200 sends current depth information of the robotic pool cleaner to the control mechanism 400, and the map planning module may establish a three-dimensional pool map. The map planning module may be embedded in or independent of the control mechanism in a hardware form (for example, a microcontroller, an embedded control mechanism, or an ASIC), or may be stored in a memory of the robotic pool cleaner in a software form, to be invoked and executed by the control mechanism, or may be a combination of the foregoing hardware form and software form.

As shown in FIG. 2 and FIG. 3, as an optional solution, the shell 100 includes a body 110 and a partition 120. The partition 120 and the body 110 form an accommodating cavity 130, and the sensing part 210 is disposed in the accommodating cavity 130. In this way, a static pressure environment is provided for the sensing part 210. This helps ensure accuracy of a detection result of the sensing part 210.

In some embodiments, the body 110 is provided with a recessed first groove. The partition 120 covers an opening of the first groove to form the accommodating cavity 130 with the first groove. The partition 120 is provided with a first water through hole 121. When the robotic pool cleaner enters the water, the water in the pool may enter the accommodating cavity 130 through the first water through hole 121 and then fill the accommodating cavity 130. After the accommodating cavity 130 is fully filled, there is no flow of water in the accommodating cavity 130, so there is no dynamic pressure, but only static pressure, thereby providing a stable static pressure environment for the sensing part 210.

In some embodiments, the partition 120 is detachably fitted with the body 110, so that the partition 120 can be quickly mounted to and detached from the body 110. When the robotic pool cleaner works, if there are a large quantity of impurities in the accommodating cavity 130, the detection result of the sensing part 210 may be easily affected. Therefore, after the robotic pool cleaner has been used for a period of time, the user can detach the partition 120 and clean the accommodating cavity 130.

In some embodiments, in order to facilitate mounting and detaching of the partition 120, the partition 120 is provided with at least two second grooves 122 for gripping the partition 120.

In some embodiments, the partition 120 has an L-shaped or a U-shaped cross section. The partition 120 is hermetically connected to an inner wall of the body 110 so as to form the accommodating cavity 130 between the partition 120 and the body 110, and the body 110 is provided with a first water through hole 121. In other words, the accommodating cavity 130 is formed by arranging the partition 120 inside the body 110. The sensing part 210 is disposed in the accommodating cavity 130.

As shown in FIG. 3, optionally, the first water through hole 121 is an elongated hole. A plurality of elongated holes are disposed in parallel and at intervals, so that water can flow inside and outside the partition 120, and flow stability of the water can be ensured. Moreover, the elongated holes can function as a filter that can prevent the garbage from entering the accommodating cavity 130, thereby ensuring detection accuracy of the sensing part 210.

In some embodiments, there are a plurality of first water through holes 121, and the plurality of first water through holes 121 are disposed in an array, so that water can flow inside and outside the first water through holes 121. The first water through holes 121 can also function as a filter.

In some embodiments, the water pressure sensing mechanism 200 further includes a casing covering the sensing part 210. The casing is provided with a second water through hole. The casing is utilized to further filter out impurities, so that an impurity-free environment is formed in the accommodating cavity 130 for the sensing part 210, thereby ensuring the accuracy of the detection result of the sensing part 210.

In some embodiments, the casing may be a structure that can function as a filter, for example, a filter screen or a filter casing. The filter screen or the filter casing is simple in structure. This facilitates implementation and helps reduce costs.

It should be noted that the basic principle, main features, and advantages of the present disclosure have been shown and described above. It should be understood by those skilled in the art that the present disclosure is not limited by the above implementations, and the description in the above implementations and the specification only illustrates the principle of the present disclosure. Without departing from the spirit and scope of the present disclosure, there may be various changes and improvements, which shall fall within the protection scope of the present disclosure. The protection scope of the present disclosure is defined by the appended claims and equivalents thereof.

What is claimed is:

1. A robotic pool cleaner, comprising:
a cleaning channel, wherein when the robotic pool cleaner works, garbage and sewage are drawn in through an inlet of the cleaning channel and discharged through an outlet of the cleaning channel;
a shell, wherein the cleaning channel is disposed in the shell;
a water pressure sensing mechanism, comprising a sensing part which is configured to sense a water pressure at a position where the sensing part is disposed, wherein the sensing part is disposed at an area, other than the cleaning channel, in the shell; and
an accommodating cavity configured to accommodate the sensing part;
wherein the shell is provided with a first water through hole configured to allow water in a pool to enter the accommodating cavity and then fill the accommodating cavity when the robotic pool cleaner dives into water.

2. The robotic pool cleaner as claimed in claim 1, wherein the accommodating cavity is formed by a body and a partition of the shell.

3. The robotic pool cleaner as claimed in claim 2, wherein the body is provided with a first groove, and the partition covers an opening of the first groove to form the accommodating cavity.

4. The robotic pool cleaner as claimed in claim 2, wherein the partition is provided with the first water through hole.

5. The robotic pool cleaner as claimed in claim 2, wherein the partition is detachably fitted with the body.

6. The robotic pool cleaner as claimed in claim 2, wherein the partition is provided with at least two second grooves for gripping the partition.

7. The robotic pool cleaner as claimed in claim 2, wherein the partition is hermetically connected to an inner wall of the body so as to form the accommodating cavity.

8. The robotic pool cleaner as claimed in claim 1, wherein the first water through hole is an elongated hole configured to allow water to flow into and flow out of the accommodating cavity.

9. The robotic pool cleaner as claimed in claim 1, wherein the first water through hole is an elongated hole, there are a plurality of elongated holes, and the plurality of elongated holes are arranged in parallel and at intervals.

10. The robotic pool cleaner as claimed in claim 1, wherein there are a plurality of first water through holes, and the plurality of first water through holes are arranged in an array.

11. The robotic pool cleaner as claimed in claim 1, wherein the water pressure sensing mechanism further comprises a casing which covers the sensing part, and the casing is provided with a second water through hole.

12. The robotic pool cleaner as claimed in claim 9, wherein the casing is utilized as a filter.
